(19) United States
(12) Patent Application Publication
(10) Pub. No.: US 2019/0195337 A1
(43) Pub. Date: Jun. 27, 2019

(54) CAMSHAFT UNIT FOR VEHICLE

(71) Applicants: HYUNDAI MOTOR COMPANY, Seoul (KR); KIA MOTORS CORPORATION, Seoul (KR)

(72) Inventor: Jae Hee JEON, Hwaseong-si (KR)

(73) Assignees: HYUNDAI MOTOR COMPANY, Seoul (KR); KIA MOTORS CORPORATION, Seoul (KR)

(21) Appl. No.: 15/978,402

(22) Filed: May 14, 2018

(30) Foreign Application Priority Data
Dec. 22, 2017 (KR) 10-2017-0177869

(51) Int. Cl. F16H 57/12

(52) U.S. Cl. CPC F16H 57/12; F16H 2057/127

(57) ABSTRACT

A camshaft unit for a vehicle includes: a cam gear shaft-coupled to one end of a camshaft; a scissors gear provided at one side of the cam gear while having the camshaft as a concentric axis and relatively rotated with respect to the cam gear; a coil spring provided between the cam gear and the scissors gear, having one end fixed to one side surface of the cam gear and the other end fixed to the other side surface of the scissors gear; and a snap ring installed in a groove formed in one side surface of the scissors gear and inhibiting separation of the scissors gear in an axial direction. In particular, the coil spring transfers a torque of the cam gear to the scissors gear while being elastically restored depending on rotation of the cam gear.

### CROSS REFERENCE TO RELATED APPLICATION

This application claims priority to and the benefit of Korean Patent Application No. 10-2017-0177869, filed Dec. 22, 2017, which is incorporated herein by reference in its entirety.

### FIELD

The present disclosure relates to a camshaft unit for a vehicle.

### BACKGROUND

The statements in this section merely provide background information related to the present disclosure and may not constitute prior art.

Generally, valves opening and closing a combustion chamber of an engine generating power at an appropriate timing are opened and closed by a valve opening and closing mechanism connected to a crank shaft, and the engine is divided into a single overhead camshaft (hereinafter, referred to as an SOHC) engine and a double overhead camshaft (hereinafter, referred to as a DOHC) engine. In the SOHC engine, all the valves are opened by a single camshaft, and in the DOHC engine, intake and exhaust valves are opened by two camshafts, respectively, depending on a manner of driving the valves.

The DOHC engine has a complicated structure in order to operate two intake valves and two exhaust valves per cylinder, generates large noise, and consumes a larger amount of power in order to drive the respective valves as compared with the SOHC engine. However, in the DOHC engine, the two intake valves and the two exhaust valves are installed in each cylinder and are simultaneously operated by a camshaft for intake and a camshaft for exhaust, respectively, such that intake performance and exhaust performance in the combustion chamber may be improved.

In the DOHC engine as described above, one of the camshafts (i.e., a camshaft for either intake or exhaust) directly transfers power, while the other camshaft receives the power transferred from the one camshaft. To this end, an inter-cam driving system uses a gear. However, the inter-cam driving system has a limitation in reducing rattle noise inevitably generated by a backlash, which is a clearance between a driving gear and a driven gear, by improving engagement between teeth, due to engagement characteristics.

Therefore, the inter-cam driving system uses a cam gear and a scissors gear, which are backlash compensation gears using scissors spring force, in order to reduce the backlash generated between toothed gears.

A camshaft unit for a vehicle used in the related art will be described in detail with reference to FIG. 1. The camshaft unit 101 for a vehicle includes a camshaft 110 having a cam 115 formed on a circumference thereof, a cam gear 120 and a scissors gear 130 shaft-coupled to one end of the camshaft 110 and relatively rotated with a scissors spring 135 interposed therebetween, and a wave spring 140, a scissors washer 145, and a snap ring 150 sequentially assembled so that the scissors gear 130 is closely adhered to the cam gear 120 in order to hold the scissors gear 130 and the cam gear 120 together in an axial direction.

A hub 121 to which the camshaft 110 is to be coupled protrudes from the center of the cam gear 120, and a pin 122 that is to be coupled to the scissors gear 130 is formed on a plate surface of the cam gear 120.

The scissors gear 130 is maintained in a state in which it is always in contact with the cam gear 120 fixed to the camshaft 110 by elastic force of the scissors spring 135, such that a backlash becomes “0”, and thus, rattle noise is not generated during driving. In this case, a coupling portion 131 into which the hub 121 of the cam gear 120 is inserted and coupled is provided at the center of the scissors gear 130, and a pin 132 for fixing the scissors spring 135 is formed on a plate surface of the scissors gear 130.

The wave spring 140 has a wave shape, is closely adhered to an inner surface of the coupling portion 131, and presses the scissors gear 130 toward the cam gear 120 in the axial direction.

The scissors washer 145 is coupled to the inner surface of the coupling portion 131, and serves to closely adhere the scissors gear 130 toward the cam gear 120 in the axial direction together with the wave spring 140.

The snap ring 150 serves to fix the wave spring 140 and the scissors washer 145 so that the wave spring 140 and the scissors washer 145 coupled to the coupling portion 131 are not separated from the camshaft 110.

However, in the camshaft unit 101 for a vehicle according to the related art, many components are assembled to the camshaft 110, such that an assembling man-hour is increased, thereby increasing a manufacturing cost.

The contents described as the related art have been provided only to assist in understanding the background of the present disclosure and should not be considered as corresponding to the related art known to those having ordinary skill in the art.

### SUMMARY

The present disclosure provides a camshaft unit of a vehicle which utilizes reduced number of components to lower a manufacturing cost.

In one form of the present disclosure, a camshaft unit for a vehicle includes: a cam gear shaft-coupled to one end of a camshaft; a scissors gear disposed on a first side of the cam gear while having the camshaft as a concentric axis and configured to rotate relatively to the cam gear; a coil spring provided between the cam gear and the scissors gear, and having a first end fixed to a first side surface of the cam gear and a second end fixed to a second side surface of the scissors gear; and a snap ring installed in a groove formed in a first side surface of the scissors gear and configured to inhibit separation of the scissors gear in an axial direction. The coil spring is configured to transfer a torque of the cam gear to the scissors gear depending on rotation of the cam gear.

In one form, the coil spring is configured to provide elastic force in a rotation direction to the scissors gear so that the scissors gear is rotated by the cam gear, and configured to provide elastic force in the axial direction to the scissors gear so as to inhibit the scissors gear from being separated by a relative motion between the cam gear and the scissors gear.

A hub may protrude from a central portion of the cam gear toward the scissors gear so that the camshaft is coupled thereto, the hub may be inserted into a coupling portion of the scissors gear in which the groove is formed, and the coil spring may be formed to surround an outer peripheral surface of the hub.

Dowel pins may be disposed between a surface of the cam gear and a surface of the scissors gear, and the surfaces of the cam gear and the scissors gear face to each other and are provided with at least one dowel pin of the dowel pins, and the first and second ends the coil spring may be bent in a radial direction from a winding direction of the coil spring and be caught by and fixed to the dowel pins, respectively.

The dowel pins may be provided between both ends (i.e., the first and second ends) of the coil spring, and the coil spring may be provided to transfer elastic force in a direction in which both ends of the coil spring become close to each other.

In one form, a protruding portion is respectively integrally formed on a surface of the cam gear and the scissors gear, and the surfaces of the cam gear and the scissors gear face to each other, and the first and second ends of the coil spring may be bent in a radial direction and be caught by and fixed to the protruding portions, respectively.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an exploded perspective view illustrating a camshaft unit for a vehicle in the related art;

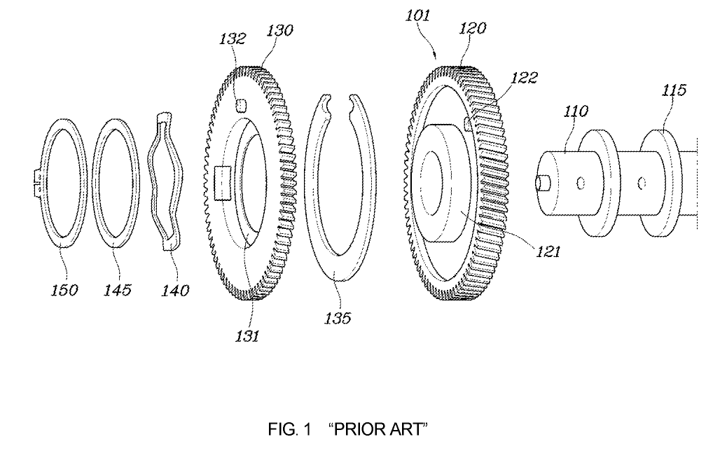

FIG. 2 is an exploded perspective view illustrating a camshaft unit for a vehicle in one form of the present disclosure; and

FIG. 3 is a side view of FIG. 2 illustrating a cam gear assembled with a coil spring.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

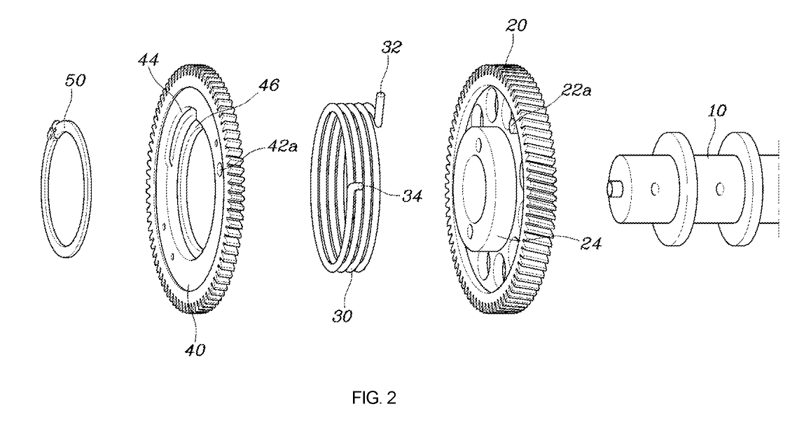

FIG. 2 is an exploded perspective view illustrating a camshaft unit for a vehicle in one form of the present disclosure.

Referring to FIG. 2, the camshaft unit for a vehicle may include a cam gear 20 shaft-coupled to one end of a camshaft 10; a scissors gear 40 disposed on one side of the cam gear 20 while having the camshaft 10 as a concentric axis and configured to rotate relative to the cam gear 20; a coil spring 30 provided between the cam gear 20 and the scissors gear 40; and a snap ring 50 installed in a groove 44 formed in one side surface of the scissors gear 40 and preventing separation of the scissors gear 40 in an axial direction. The scissors gear 40 has one end fixed to one side surface of the cam gear 20 and the other end fixed to the other side surface of the scissors gear 40, and thus transfers a torque of the cam gear 20 to the scissors gear 40 while being elastically restored depending on rotation of the cam gear 20

The cam gear 20 is directly connected to the camshaft 10, but the scissors gear 40 is not directly connected to the camshaft 10. The scissors gear 40 is connected only to the cam gear 20 via the coil spring 30, and the cam gear 20 and scissors gear 40 rotate around a concentric axis.

Therefore, the scissors gear 40 serves to remove a backlash of a gear while being relatively rotated with respect to the cam gear 20.

The coil spring 30 connects the cam gear 20 and the scissors gear 40 to each other, and may be deformed by the torque of the cam gear 20 and then transfer the torque to the scissors gear 40 while being elastically restored, thereby allowing the scissors gear 40 to be relatively rotated with respect to the cam gear 20.

The coil spring 30 is extended in a coil shape from one end thereof in a length direction and arrives at the other end thereof.

Due to such a shape, the coil shape 30 may provide elastic force in a rotation direction to the scissors gear 40 so that the scissors gear 40 is relatively rotated by the rotation of the cam gear 20, and may provide elastic force in the axial direction to the scissors gear 40 so as to inhibit or prevent the scissors gear 40 from being separated by a relative motion between the cam gear 20 and the scissors gear 40 in the axial direction.

In detail, a hub 24 protrudes from a central portion of the cam gear 20 toward the scissors gear 40 so that the camshaft 10 is coupled thereto. The hub 24 is inserted into a coupling portion 44 of the scissors gear 40 in which the groove 44 is formed, and the coil spring 30 is formed to surround an outer peripheral surface of the hub 24.

That is, the camshaft 10 is coupled to the hub 24 to be directly connected to the cam gear 20, and the hub 24 of the cam gear 20 is inserted into the coupling portion 44 of the scissors gear 40.

The coil spring 30 has a shape in which it surrounds the outer peripheral surface of the hub 24 to provide the elastic force in the rotation direction and provide the elastic force in the axial direction.

For example, one end of the coil spring 30 is fixed to one side surface of the cam gear 20, and the other end of the coil spring 30 is fixed to the other side surface of the scissors gear 40. Therefore, when the cam gear 20 is rotated in one direction, one end of the coil spring 30 is rotated in one direction together with the cam gear 20.

Here, since the coil spring 30 is formed of an elastic material, one end of the coil spring is first rotated in one direction, and an entire shape of the coil spring 30 is rotated in one direction with a fine time difference by elastic force restoring the coil spring 30 to its original shape.

Due to an action of the force described above, the scissors gear 40 is relatively rotated with a fine time difference with respect to the rotation of the cam gear 20 to remove the backlash, which is a clearance between a driving gear and a driven gear, thereby reducing or preventing generation of rattle noise. The coil spring substitutes for an existing scissors spring.

In addition, the coil spring 30 transfers the elastic force in the axial direction, and is basically formed at a thickness at which the cam gear 20 and the scissors gear 40 are formed while having an appropriate distance therebetween.

For example, in the case in which force by which the scissors gear 40 becomes close to the cam gear 20 while being relatively rotated is generated, since both ends of the coil springs 30 are fixed to the cam gear 20 and the scissors gear 40, respectively, the coil spring 30 is compressed, and may then apply the elastic force preventing the scissors gear 40 from being separated from its original position to the scissors gear 40 while being stretched by restoring force.

On the other hand, in the case in which force by which the scissors gear 40 becomes distant from the cam gear 20 while being relatively rotated is generated, since both ends of the coil springs 30 are fixed to the cam gear 20 and the scissors gear 40, respectively, the coil spring 30 is stretched, and then may prevent separation of the scissors gear 40 while being again compressed by restoring force. Therefore, the coil spring 30 may substitute for a role of an existing wave spring.

In one form of the present disclosure as illustrated in FIG. 2, dowel pins 22a and 42a are coupled, respectively, to surfaces of the cam gear 20 and the scissors gear 40 facing each other, and one end and the other end the coil spring 30 in a winding direction may be bent in a radial direction and be caught by and fixed to the dowel pins 22a and 42a, respectively.

In this case, the dowel pins 22a and 42a may be provided between both ends of the coil spring 30, and the coil spring 30 may be provided to transfer the elastic force in a direction in which both ends of the coil spring 30 become close to each other.

When the cam gear 20, the coil spring 30, and the scissors gear 40 are assembled to each other, a separate assembling pin is inserted into the cam gear 20, and one end and the other end of the coil spring 30 are caught by the dowel pin 22a and the assembling pin, respectively, in a state in which the coil spring 30 is stretched so that both ends of the coil spring 30 become distant from each other. In this case, the assembling pin is inserted into a point more distant from the dowel pin 22a of the cam gear 20 as compared with the dowel pin 42a of the scissors gear 40.

Then, the scissors gear 40 is disposed to face the coil spring 30, and the assembling pin is then removed to allow the other end of the coil spring 30 to be caught by the dowel pin 42a of the scissors gear 40, thereby completing the assembling of the cam gear 20, the coil spring 30, and the scissors gear 40.

Therefore, elastic restoring force may continuously act in a direction in which both ends of the coil spring 30 become close to each other.

That is, the coil spring 30 is fixed by a simple connection relationship between the cam gear 20 and the scissors gear 40, and transfers power to the scissors gear 40 so that the scissors gear 40 is relatively rotated depending on the rotation of the cam gear 20, thereby making it possible to remove the backlash between the driving gear and the driven gear.

Here, the dowel pins 22a and 42a are inserted into and fastened to insertion holes drilled in the cam gear 20 and the coil spring 30, respectively, to be coupled to the respective gears.

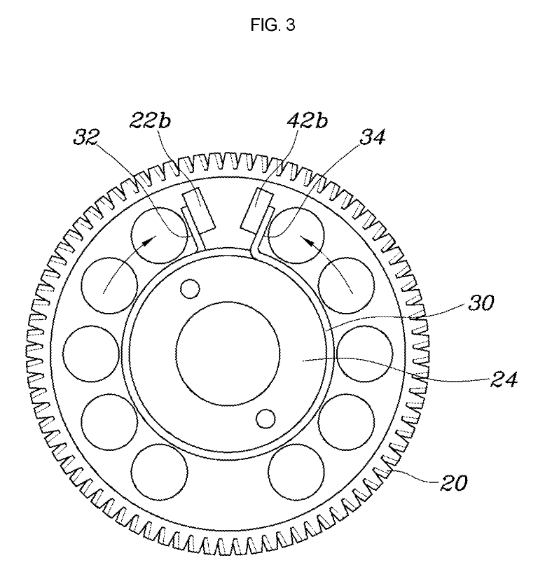

FIG. 3 is a side view illustrating a form in which a cam gear and a coil spring of FIG. 2 are coupled to each other.

In another example of the present disclosure as illustrated in FIG. 3, the cam gear 20 and the scissors gear 40 are manufactured so that protruding portions 22b and 42b are formed integrally with the cam gear 20 and the scissors gear 40, respectively, on surfaces of the cam gear 20 and the scissors gear 40 facing each other, and one end and the other end the coil spring 30 in a winding direction may be bent in a radial direction and be caught by and fixed to the protruding portions 22b and 42b, respectively.

The protruding portions 22b and 42b are provided between both ends of the coil spring 30, and both ends of the coil spring 30 receive elastic force in a direction in which they become close to each other.

In this case, a process of manufacturing and assembling a separate dowel pin is omitted, and the protruding portions 22b and 42b are processed to be formed integrally with the cam gear 20 and the scissors gear 40, respectively, when the cam gear 20 and the scissors gear 40 are molded, such that a time and a cost required for manufacturing and assembling a separate component may be reduced.

According to the camshaft unit for a vehicle having the structure as described above, a manufacturing cost, a volume, and a weight of the camshaft unit for a vehicle may be reduced as the reduced number of internal components are used.

Although the present disclosure has been shown and described with respect to specific forms, it will be apparent to those having ordinary skill in the art that the present disclosure may be variously modified and altered without departing from the spirit and scope of the present disclosure.

What is claimed is:

1. A camshaft unit for a vehicle, comprising:
a cam gear coupled to first end of a camshaft;
a scissors gear disposed on a first side of the cam gear while having the camshaft as a concentric axis and configured to rotate relatively to the cam gear;
a coil spring provided between the cam gear and the scissors gear, and having a first end fixed to a first side surface of the cam gear and a second end fixed to a second side surface of the scissors gear, the coil spring configured to transfer a torque of the cam gear to the scissors gear depending on rotation of the cam gear; and
a snap ring installed in a groove formed in a first side surface of the scissors gear and configured to inhibit separation of the scissors gear in an axial direction.

2. The camshaft unit of claim 1, wherein the coil spring is configured to provide elastic force in a rotation direction to the scissors gear so that the scissors gear is rotated by the cam gear, and configured to provide elastic force in the axial direction to the scissors gear so as to inhibit the scissors gear from being separated by a relative motion between the cam gear and the scissors gear.

3. The camshaft unit of claim 2, wherein a hub protrudes from a central portion of the cam gear toward the scissors gear so that the camshaft is coupled thereto,
the hub is inserted into a coupling portion of the scissors gear in which the groove is formed, and
the coil spring is configured to surround an outer peripheral surface of the hub.

4. The camshaft unit of claim 3, wherein dowel pins are disposed between a surface of the cam gear and a surface of the scissors gear,
wherein the surfaces of the cam gear and the scissors gear face to each other and are provided with at least one dowel pin of the dowel pins, and
the first and second ends the coil spring are bent in a radial direction and are caught by and fixed to the dowel pins, respectively.

5. The camshaft unit of claim 4, wherein
the dowel pins are provided between the first and second ends of the coil spring, and
the coil spring is provided to transfer elastic force in a direction in which the first and second ends of the coil spring become close to each other.

6. The camshaft unit of claim 3, wherein a protruding portion is respectively integrally formed on a surface of the cam gear and the scissors gear, and the surfaces of the cam gear and the scissors gear face to each other, and
wherein the first and second ends the coil spring are bent in a radial direction and are caught by and fixed to the protruding portions, respectively.
